(19) United States
(12) Patent Application Publication
(10) Pub. No.: US 2022/0085389 A1
(43) Pub. Date: Mar. 17, 2022

(54) Method of Electrode Fabrication for Super-Thin Flow-Battery

(71) Applicant: Institute of Nuclear Energy Research, Atomic Energy Council, Executive Yuan, R.O.C., Taoyuan (TW)

(72) Inventors: Ning-Yih Hsu, Taoyuan (TW); Hung-Hsien Ku, Taoyuan (TW); Qiao-Ya Chen, Taoyuan (TW)

(21) Appl. No.: 17/019,451

(22) Filed: Sep. 14, 2020

(51) Int. Cl. H01M 8/0228; H01M 8/0258; H01M 8/1004

(52) U.S. Cl. CPC H01M 8/0228; H01M 2008/1095; H01M 8/1004; H01M 8/0258

(57) ABSTRACT

A method is provided to fabricate electrode used in super-thin flow-battery. A semi-finished cured film is prepared though colloid-mixing, impregnating, and baking. The film is pressed with different materials for fabricating various types of polar plate according to applications. Thus, a thin electrode is fabricated to contain a supporting member with thickness controllable. The electrode obtains excellent resistance to the permeation of vanadium ions; vertical-penetration volume resistance is controlled by adjusting the blending ratio of carbonaceous matter; and the demand of conductivity is met. Besides, the film is prepared to obtain a bipolar plate, a copper-containing current-collecting end plate, or other electrode material like carbon felt, carbon paper, etc. to be combined into an integrated electrode mold. Consequently, different products are obtained with different materials, where the fabrication is simple without using a high-temperature carbonization device and the component cost of flow battery is effectively reduced.

### TECHNICAL FIELD OF THE INVENTION

The present invention relates to electrode fabrication; more particularly, to obtaining a composite material impregnated for fabricating a thin electrode containing a supporting material with thickness controllable, where a bipolar plate, a copper-containing current-collecting plate, or an integrated electrode mold, obtained with other electrode material combined, is prepared according to conditions.

### DESCRIPTION OF THE RELATED ARTS

In recent years, bipolar plate as a key component contained in fuel cell applications catches more attention with the gradual expansion of the market. The bipolar plate gradually changes from a highly densified graphite plate at early age to a composite carbon(C)-plate.

The plate is of a C—C composite material, which is obtained with a C fiber and an epoxy base. Porvair Co. dedicates to the the casting process of initial slurry. The slurry is made by suspending a C fiber (approximately 400 micrometers (μm)×10 μm) in a mixture of water and a phenolic resin. A phenolic binder is used to press the assembly in a mold to obtain a shape having a flow-field feature to be cured. Then, resin carbonization and chemical vapor infiltration (CVI) are processed at a high temperature. The purpose of the carbonization is to change the insulating resin into a conductive carbon material. During the carbonization, a certain percentage of weight of the resin will be lost with pores thus made. For blocking gas leakage owing to the pores, the process of CVI is required. This is a process of depositing carbon at the pores through CVI, so that the reactants do not permeate through the plate and the surface conductivity is greatly increased. The CVI obtains the plate to be processed through thermal cracking reaction at 1500 celsius degrees (° C.) with a methane gas flown in. Thus, C particles are deposited on the periphery of the carbon fiber. The increase of temperature for the CVI can cause the pyrolysis of the phenolic binder to produce a pure C—C composite material with the surface conductivity increased thereby, where the volume resistance of the whole C—C composite material is reduced, as shown in FIG. 2. However, this prior art uses relatively expensive and complex utilities for CVI, where argon is required to be flown in, and the desired temperature must reach a high temperature of 1350˜1500° C. Of no doubt, it is an expensive process scheme. Besides, only the bipolar plate can be fabricated yet various types of plates are not available. Not only the process is complex and lack in flexibility, but also the production cost is too high.

Another prior art discloses a resin composition and conductive resin film, which uses a melt mixer to make particles with a calendaring machine or an extruder to cool-mold through a T-molding machine for obtaining a mold. However, this prior art uses a thermosetting resin for fabrication. The resin is poor in thermal resistance and rigidity, and only a single product can be fabricated.

The above prior arts either obtain a bipolar plate only or fabricate a single product alone. The lack of flexibility in production is not solved, while the production cost is expensive and mass production becomes difficult. Hence, the prior arts do not fulfill all users' requests on actual use.

### SUMMARY OF THE INVENTION

The main purpose of the present invention is to prepare a semi-finished cured film though steps of colloid-mixing, impregnating and baking, where the semi-finished cured film is pressed with different materials to fabricate various types of polar plate according to applications.

Another purpose of the present invention is to obtain a composite material processed through impregnation for fabricating a thin electrode containing a supporting material with thickness controllable, where the fabricated obtains excellent resistance to the permeation of vanadium ions; vertical-penetration volume resistance is controlled by adjusting the blending ratio of conductive carbonaceous matter; and the demand of conductivity is thus met.

Another purpose of the present invention is to prepare the semi-finished cured film according to conditions to obtain a bipolar plate, a copper-containing current-collecting plate, or an electrode mold integrated with other electrode material like carbon felt, carbon paper, etc., where different products are obtained with different materials; the fabrication is simple without using a high-temperature carbonization device and the component cost of flow battery is effectively reduced.

To achieve the above purposes, the present invention is a method of electrode fabrication for super-thin flow-battery, comprising steps of (a) colloid-mixing, (b) impregnating, (c) baking, and and (d) pressing, where, in step (a), a crosslinking agent, a conductive powder, and a thermosetting resin are added to be mixed for obtaining a colloidal material based on a weight ratio to form a colloidal solution through more than 10 minutes (min) of homogeneous stirring; in step (b), a supporting member is impregnated in the colloidal solution to control resin content (RC); in step (c), the impregnated colloidal solution is baked to be dried for obtaining a semi-finished cured film; in step (d), the semi-finished cured film is laminated based on a demand of thickness to be pressed under a gage pressure not smaller than 30 kilogram-forces per square centimeter and a material temperature higher than a crosslinking-reaction temperature while maintaining the material temperature at least 110 min to obtain a finished polar plate; and, where the finished polar plate is an electrode having a volume resistance not bigger than 10⁻¹ ohm-meters applicable to super-thin flow-battery. Accordingly, a novel method of electrode fabrication for super-thin flow-battery is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention; and

FIG. 2 is the view of the prior art.

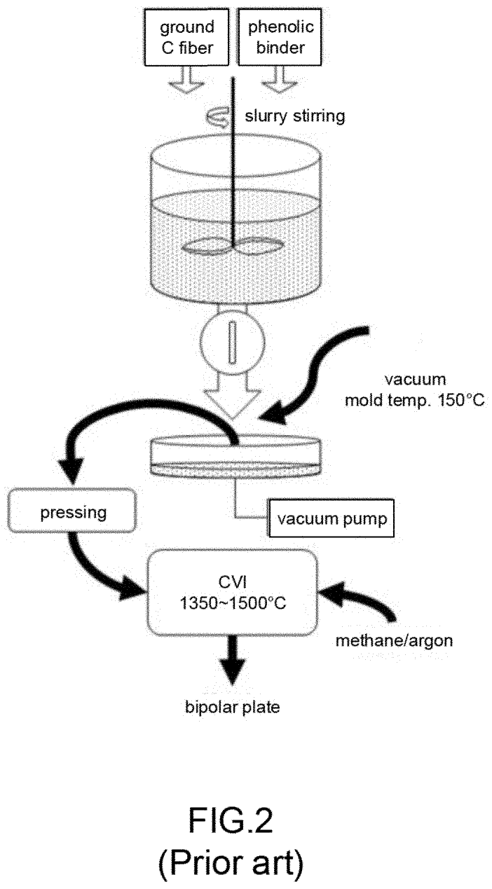

### DESCRIPTION OF THE PREFERRED EMBODIMENT

The following description of the preferred embodiment is provided to understand the features and the structures of the present invention.

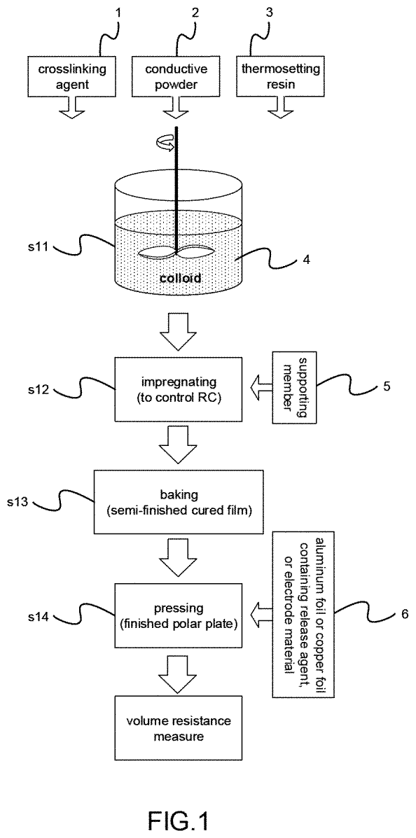

Please refer to FIG. 1, which is a flow view showing a preferred embodiment according to the present invention. As shown in the figure, the present invention is a method of electrode fabrication for super-thin flow-battery, comprising the following steps:

(a) Colloid-mixing s11: A crosslinking agent 1 is added with a conductive powder 2 and a thermosetting resin 3 to be mixed for obtaining a colloidal material based on a weight ratio to form a colloidal solution 4 through more than 10 minutes (min) of homogeneous stirring.

(b) Impregnating s12: A supporting member 5 is impregnated in the colloidal solution 4 to control resin content (RC).

(c) Baking s13: The impregnated colloidal solution 4 is baked to be dried for obtaining a semi-finished cured film.

(d) Pressing s14: The semi-finished cured film is laminated to be pressed based on a demand of thickness under a gage pressure not smaller than 30 kilogram-forces per square centimeter (kgf/cm²) and a material temperature higher than a crosslinking-reaction temperature while maintaining the material temperature at least 110 minutes (min) for obtaining a finished polar plate, where the finished polar plate is an electrode having a volume resistance not bigger than 10⁻¹ ohm-meters (ohm·m) applicable to super-thin flow-battery. Thus, a novel method of electrode fabrication for super-thin flow-battery is obtained.

The crosslinking agent is an amine; an aramid; a nitrogen-containing heterocyclic organic compound; a phenol; a composition having phosphorus-containing group; an anhydride composition; a highly nitrogenous composition; or a combination of more than one of the above. Therein, the amine is dicyandiamide (Dicy); the phenol is phenol novolac (PN); the composition having phosphorus-containing group is 9,10-dihydro-9-oxa-10-phosphaphenanthrene-10-oxide (DOPO); the anhydride composition is styrene-maleic anhydride (SMA); and the highly nitrogenous composition is amino triazine novolac (ATN).

The conductive powder comprises not less than 95 percent of fixed carbon having a granular diameter not bigger than 100 meshes; and is a conductive powder composition of highly carbonaceous matter and low-ratio ash (not more than 1%). The conductive powder can be further added with a small amount of carbon nanotube to improve volume resistance, where the carbon nanotube is a coaxial tube forming into at least one single layer and is of carbon fiber, also named as carbon filament, carbon tube, graphite fiber, carbon nanofiber, etc., having a diameter of 0.5˜150 nanometers (nm) and a length of 0.1˜250 micrometers (μm).

The thermosetting resin is a halogen resin or a non-halogen resin. Therein, the halogen resin is a brominated epoxy resin having a bromine content of 20˜50% and is obtained through a basic epoxy resin reacting with tetrabromobisphenol A (TBBA), where the basic epoxy resin is bisphenol A epoxy resin or bisphenol F epoxy resin; the non-halogen resin is a basic epoxy resin or a phosphorus-containing epoxy resin, where the phosphorus-containing epoxy resin is an epoxy resin having phosphorus-containing side-chain obtained through the basic epoxy resin reacting with organic ring phosphide (HCA); and the basic epoxy resin is bisphenol A epoxy resin, bisphenol F epoxy resin, phenol novolac epoxy resin, cresol novolac epoxy resin, phenol novolac epoxy resin, or bisphenol A novolac epoxy resin, which reacts with the organic ring phosphide (HCA) to obtain the epoxy resin having phosphorus-containing side-chain.

Furthermore, the non-halogen epoxy resin is a phosphorus nitrogen epoxy resin, and the phosphorus nitrogen epoxy resin has a formula as shown in Formula (1):

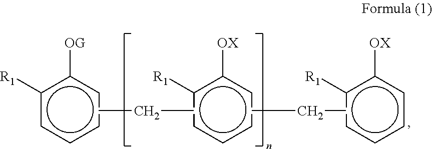

where n is 1˜30; R₁ is an element group of hydrogen (H) or carbon-1 to carbon-6 (C₁˜C₆); G is a group having a formula as shown in Formula (2); each one of Xs is a group of G or a group having a formula as shown in Formula (3); at least one of the Xs is the group having the formula as shown in Formula (3); and the phosphorus nitrogen epoxy resin has a molecular weight of 400-3000 and contains the following sub-formulas:

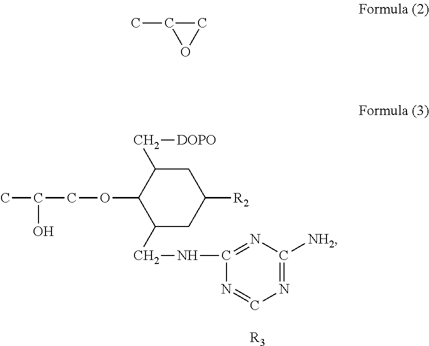

where R₂ and R₃ are element groups of H or C₁˜C₆.

The epoxial thermosetting resin has a typical structural formula as follows:

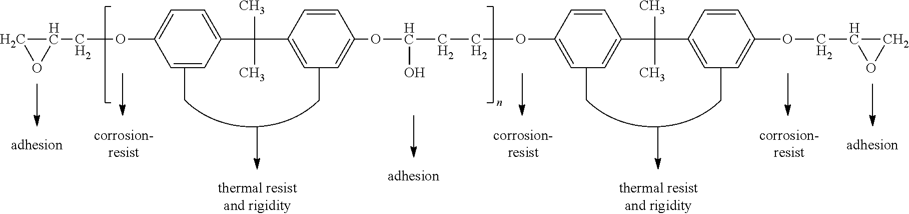

With the structure of the epoxial thermosetting resin, the material itself obtains the following features:

1. Strong adhesion: A hydroxyl group, an ether bond, and an epoxy group having great activity will be generated as structural members after the epoxy thermosetting resin reacts with the amine. These structural members can make the molecule of the epoxy thermosetting resin generate chemical bonds on adjacent interfaces, where the epoxy group can process crosslinking polymerization reaction under the function of a curing agent for generating a three-directional network-structure macro-molecule to maintain a certain cohesion of the molecule itself.

2. Good mechanical strength: The cured epoxy thermosetting resin has a strong cohesion so that the molecular structure has a very compact arrangement for obtaining a mechanical strength relatively higher than other resins.

3. Stability and good processing features: The epoxy thermosetting resin does not produce highly volatile matters during curing and chemical stability is high, which is suitable for many different processing conditions. Besides, after being cured, the epoxy thermosetting resin forms its main bond through three-directionally crosslinking ether bond with benzene ring. Both acid resistance and alkali resistance are obtained with performance better than novolac resin and polyester resin.

4. Good thermal resistance feature: In general, the curing agent of the epoxy thermosetting resin has a thermal resistance around 100 celsius degrees (° C.), while the epoxy at a specific thermal resistance level can have a thermal resistance for more than 200° C.

5. Good electrical insulation feature: After being cured, the epoxy thermosetting resin has a low water absorption, where reactive groups and free ions no longer exist. Thus, an excellent electrical insulation feature is obtained.

6. Low curing shrinkage: The curing process of the epoxy thermosetting resin mainly relies on the polymerization reaction of the epoxy group in addition with loop opening. Thus, products with low molecular weight are not generated during curing. Furthermore, because the intermolecular hydrogen bonds are functioned to arrange the molecules more closely, the curing shrinkage of the epoxy thermosetting resin is the lowest among all kinds of thermosetting resins, where common resins include novolac resin, organic silicon resin, polyester resin, and epoxy resin.

The curing agents are categorized as follows based on reaction mechanism and curing temperature:

1. Based on reaction mechanism:

(1) Functioned as catalyst, like third-grade amines, complex of boron trifluoride-amine, etc.

(2) Reacted with functional group of epoxy thermosetting resin, like amine, anhydride, isocyanate, etc.

2. Based on curing reaction temperature: Generally speaking, the use of a curing agent having a high curing temperature would obtain a cured object with better thermal resistance.

(1) Cured at room temperature, like polyamide resin, diethylene triamine, etc.

(2) Cured at middle temperature, like diethyl amino propyl amine, etc.

(3) Cured at high temperature, like Dicy, cyanate ester, etc.

The thermosetting resin provided according to the present invention is an epoxy thermosetting resin. After being uniformly mixed with a certain ratio of a crosslinking agent for a crosslinking reaction with curing, a three-dimensional network structure is formed to thus obtain specific physical and chemical features along with mechanical features, thermal resistance, and insulation as well as the functions of adhesion, corrosion prevention, molding, etc. Therefore, the epoxy resin material is not only used in technological fields, like those of coating paints, adhesion, insulation, civil construction materials, as well as materials for molding various electronic devices and for packaging integrated circuits and circuit boards, etc. It is also used in advanced technological fields, like packaging materials and composite materials used in electronics, spaceflight, etc.

The supporting member is fine-mesh soft iron net, fine-mesh soft carbon net, conductive carbon fiber woven fabric, or glass-fiber woven fabric. Therein, the conductive carbon fiber woven fabric is a carbon fiber fabric of 12K greater, i.e. at least 12,000 single-filaments within a bundle of carbon fibers; and, thereby, good conductivity is affirmed. The glass-fiber woven fabric has a basis weight lower than 120 grams per square meter.

The electrode material is carbon felt, carbon paper, the finished polar plate, or one of their combinations to be combined with the semi-finished cured film for forming an integrated mold, where the finished polar plate is a bipolar plate or a copper-containing current-collecting end plate.

On using the present invention, a crosslinking agent, a conductive powder composition of highly carbonaceous matter and low-ratio ash, and a thermosetting resin are added to be mixed for obtaining a colloidal material based on a weight ratio to form a colloidal solution through more than 10 min of homogeneous stirring.

The colloidal solution is directed into an impregnating tank; and a conductive carbon fabric or glass fabric is used as a supporting member to be directed into the impregnating tank for adhering the colloidal solution on the supporting member.

The supporting member with the colloidal solution adhered thereon is baked to be dried for forming a semi-finished cured film.

A thermal-resistant aluminum foil or copper foil containing a release agent is selected to be laminated with the semi-finished cured film for pressing based on a demand of thickness under a gage pressure not smaller than 30 kgf/cm² and a material temperature higher than a crosslinking-reaction temperature while maintaining the material temperature at least 110 min. The finished polar plate is obtained after laminating. After measuring volume resistance, not greater than 10⁻¹ ohm·m is all required to finish an electrode for a super-thin flow-battery.

For practical fabrications, the semi-cured film can produce various types of end plate according to applications, including:

In a first state-of-use, the semi-finished cured film is pressed with carbon felt to form an integrated thin polar plate containing carbon felt.

In a second state-of-use, the semi-finished cured film is pressed with carbon paper to form an integrated thin polar plate containing carbon paper.

In a third state-of-use, a finished polar plate containing copper foil at a side, the finished polar plate are pressed with carbon felt to form an integrated thin polar plate containing carbon felt (applied as end plate).

In a fourth state-of-use, a finished polar plate containing copper foil at a side, the finished polar plate are pressed with carbon paper to form an integrated thin polar plate containing carbon paper (applied as end plate).

Accordingly, the present invention uses a composite material to be processed with impregnation for fabricating a thin electrode containing a supporting material with thickness controllable. Therein, the fabricated obtains excellent resistivity to the permeation of vanadium (V) ions; vertical-penetration volume resistance is controllable by adjusting the blending ratio of conductive carbonaceous matter; and the demand of conductivity is thus met. Moreover, the semi-finished cured film contained within is prepared according to conditions for obtaining a bipolar plate, a copper-containing current-collecting plate, or other electrode material like carbon felt, carbon paper, etc. to be combined to form an integrated electrode mold. Consequently, different products are obtained with different materials, where the fabrication is simple without using a high-temperature carbonization device and the component cost of flow battery is effectively reduced.

To sum up, the present invention is a method of electrode fabrication for super-thin flow-battery, where a composite material is processed with impregnation for fabricating a thin electrode containing a supporting material with thickness controllable; the fabricated obtains excellent resistivity to the permeation of V ions, vertical-penetration volume resistance is controlled by adjusting the blending ratio of conductive carbonaceous matter, and the demand of conductivity is thus met; and the semi-finished cured film contained within is prepared according to conditions for obtaining a bipolar plate, a copper-containing current-collecting plate, or other electrode material like carbon felt, carbon paper, etc. to be combined to form an integrated electrode mold.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of electrode fabrication for super-thin flow-battery, comprising steps of:
(a) colloid-mixing: adding a crosslinking agent, a conductive powder, and a thermosetting resin to be mixed to obtain a colloidal material based on a weight ratio to obtain a colloidal solution through more than 10 minutes (min) of homogeneous stirring;
(b) impregnating: impregnating a supporting member in said colloidal solution to control resin content (RC);
(c) baking: baking to dry said impregnated colloidal solution to obtain a semi-finished cured film; and
(d) pressing: laminating said semi-finished cured film to be pressed based on a demand of thickness under a gage pressure not smaller than 30 kilogram-forces per square centimeter and a material temperature higher than a crosslinking-reaction temperature while maintaining said material temperature at least 110 min to obtain a finished polar plate,
wherein said finished polar plate is an electrode having a volume resistance not bigger than 10⁻¹ ohm-meters applicable to super-thin flow-battery.

2. The method according to claim 1,
wherein said crosslinking agent is selected from a grouping consisting of an amine; an aramid; a nitrogen-containing heterocyclic organic compound; a phenol; a composition having phosphorus-containing group; an anhydride composition; a highly nitrogenous composition; and a combination of more than one of the above.

3. The method according to claim 2,
wherein said amine is dicyandiamide; said phenol is phenol novolac; said composition having phosphorus-containing group is 9,10-dihydro-9-oxa-10-phosphaphenanthrene-10-oxide (DOPO); said anhydride composition is styrene-maleic anhydride (SMA); and said highly nitrogenous composition is amino triazine novolac (ATN).

4. The method according to claim 1,
wherein said conductive powder contains not less than 95 percent of fixed carbon having a granular diameter not bigger than 100 meshes; and is a conductive powder composition of highly carbonaceous matter and low-ratio ash (not more than 1%).

5. The method according to claim 4,
wherein said conductive powder is further added with a carbon nanotube, being a coaxial tube forming into at least one single layer and being of a carbon fiber having a diameter of 0.5˜150 nanometers (nm) and a length of 0.1˜250 micrometers (μm).

6. The method according to claim 1,
wherein said thermosetting resin is selected from a grouping consisting of a halogen resin and a non-halogen resin.

7. The method according to claim 6,
wherein said halogen resin is a brominated epoxy resin having a bromine content of 20˜50% and is obtained through a basic epoxy resin reacting with tetrabromobisphenol A (TBBA).

8. The method according to claim 7,
wherein said basic epoxy resin is selected from a grouping consisting of bisphenol A epoxy resin and bisphenol F epoxy resin.

9. The method according to claim 6,
wherein said non-halogen resin is selected from a grouping consisting of a basic epoxy resin and a phosphorus-containing epoxy resin; and said phosphorus-containing epoxy resin is an epoxy resin having phosphorus-containing side-chain obtained through said basic epoxy resin reacting with organic ring phosphide.

10. The method according to claim 9,
wherein said basic epoxy resin is selected from a grouping consisting of bisphenol A epoxy resin, bisphenol F epoxy resin, phenol novolac epoxy resin, cresol novolac epoxy resin, naphthol novolak epoxy resin, and bisphenol A novolac epoxy resin.

11. The method according to claim 6,
wherein said non-halogen epoxy resin is a phosphorus nitrogen epoxy resin and said phosphorus nitrogen epoxy resin has a formula as shown in Formula (1): 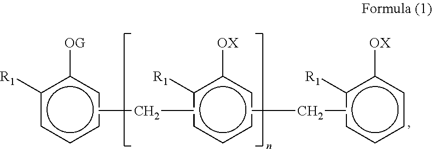
wherein n is 1˜30; R₁ is a group of an element selected from a grouping consisting of hydrogen (H) and carbon-1 to carbon-6 (C₁˜C₆); G is a group having a formula as shown in Formula (2); each one of Xs is a group selected from a grouping consisting of G and a group having a formula as shown in Formula (3); at least one of said Xs is said group having said formula as shown in Formula (3); and
wherein said phosphorus nitrogen epoxy resin has a molecular weight of 400˜3000 and contains the following sub-formulas: 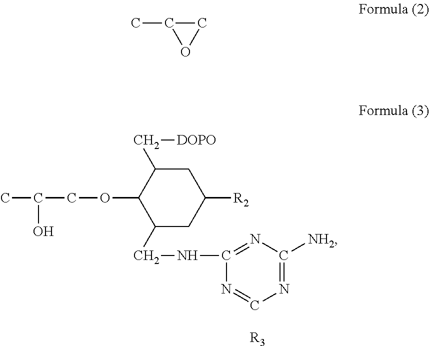
wherein R₂ and R₃ are groups of an element selected from a grouping consisting of H and C₁˜C₆.

12. The method according to claim 1,
wherein said supporting member comprises a bundle of carbon fibers formed into a woven fabric selected from a grouping consisting of a conductive carbon-fiber woven fabric having at least 12,000 single-filaments; and a glass-fiber woven fabric having a basis weight lower than 120 grams per square meter.

13. The method according to claim 1,
wherein said supporting member is selected from a grouping consisting of a fine-mesh soft-iron net and a graphite woven fabric.

14. The method according to claim 1,
wherein said finished polar plate is selected from a grouping consisting of a polar plate not containing copper foil; and a polar plate containing copper foil at a side.

15. The method according to claim 1,
wherein said electrode material is selected from a grouping consisting of carbon felt, carbon paper, said finished polar plate, and a combination of more than one of the above to be combined with said semi-finished cured film to obtain an integrated mold.

16. The method according to claim 1,
wherein said finished polar plate is a bipolar plate; a copper-containing current-collecting end plate; and an electrode mold integrated with said electrode material contained within.
